(19) United States
(12) Patent Application Publication
(10) Pub. No.: US 2008/0306931 A1
(43) Pub. Date: Dec. 11, 2008

(54) Event Weighting Method and System

(76) Inventors: Chad Brower, Campbell, CA (US); George H. John, Redwood City, CA (US)

Correspondence Address: STATTLER - SUH PC, 60 SOUTH MARKET STREET, SUITE 480, SAN JOSE, CA, 95113, US

(21) Appl. No.: 11/759,114

(22) Filed: Jun. 6, 2007

(51) Int. Cl. G06F 7/00

(52) U.S. Cl. 707/5

(57) ABSTRACT

A system and method to facilitate automatic weighting of events in a network and targeting of advertising information to users within the network based on assigned event weights are described. Multiple events associated with a user are retrieved from a data storage module. Each event is further analyzed to extract one or more event features. A weight parameter value is further calculated for each retrieved event. Each event is further assigned to a predetermined category based on the calculated weight parameter value. Finally, each event and the associated weight parameter value are stored within the data storage module in connection with the predetermined category.

### TECHNICAL FIELD

The present invention relates generally to the field of network-based communications and, more particularly, to a system and method to facilitate automatic weighting of events in a network and targeting of advertising information to users within the network based on assigned event weights.

### BACKGROUND OF THE INVENTION

The explosive growth of the Internet as a publication and interactive communication platform has created an electronic environment that is changing the way business is transacted. As the Internet becomes increasingly accessible around the world, users need efficient tools to navigate the Internet and to find content available on various websites.

Internet portals provide users an entrance and guide into the vast resources of the Internet. Typically, an Internet portal provides a range of search, email, news, shopping, chat, maps, finance, entertainment, and other content and services. Thus, the information presented to the users needs to be efficiently and properly categorized and stored within the portal.

In addition, when a user visits certain locations on the Internet (e.g., web sites), including an Internet portal, the user enters information in the form of online activity. This information may be recorded and analyzed to determine behavioral patterns and interests of the user. In turn, these behavioral patterns and interests may be used to target the user to provide a more meaningful and rich experience on the Internet, such as an Internet portal site. For example, if interests in certain products and services of the user are determined, advertisements pertaining to those products and services may be served to the user. A behavior targeting system that serves advertisements benefits both the advertiser, who provides their message to a target audience, and a user that receives advertisements in areas of interest to the user.

### SUMMARY OF THE INVENTION

A system and method to facilitate automatic weighting of events in a network and targeting of advertising information to users within the network based on assigned event weights are described. Multiple events associated with a user are retrieved from a data storage module. Each event is further analyzed to extract one or more event features. A weight parameter value is further calculated for each retrieved event. Each event is further assigned to a predetermined category based on the calculated weight parameter value. Finally, each event and the associated weight parameter value are stored within the data storage module in connection with the predetermined category.

Other features and advantages of the present invention will be apparent from the accompanying drawings, and from the detailed description, which follows below.

### BRIEF DESCRIPTION OF THE DRAWINGS

The present invention is illustrated by way of example and not intended to be limited by the figures of the accompanying drawings in which like references indicate similar elements and in which:

FIG. 1 is a flow diagram illustrating an event processing sequence, according to one embodiment of the invention;

FIG. 2 is a block diagram illustrating an exemplary network-based entity containing a system to facilitate automatic event weighting and categorization, according to one embodiment of the invention;

FIG. 3 is a block diagram illustrating the system to facilitate automatic event weighting and categorization within the network-based entity, according to one embodiment of the invention;

FIG. 4 is a flow diagram illustrating a method to facilitate automatic categorization of events in a network, according to one embodiment of the invention;

FIG. 5 is a block diagram illustrating a generalized behavioral targeting system;

FIG. 6 is a block diagram illustrating a targeting system, according to one embodiment of the invention;

FIG. 7 is a flow diagram illustrating a method to facilitate automatic scoring of users in a network, according to one embodiment of the invention;

FIG. 8 is a flow diagram illustrating a method to facilitate automatic scoring of users in a network, according to an alternate embodiment of the invention;

FIG. 9 is a diagrammatic representation of a machine in the exemplary form of a computer system within which a set of instructions may be executed.

### DETAILED DESCRIPTION

A system and method to facilitate automatic weighting of events in a network and targeting of advertising information to users within the network based on assigned event weights are described. In the following description, numerous details are set forth for the purpose of explanation. However, one of ordinary skill in the art will realize that the invention may be practiced without the use of these specific details. In other instances, well-known structures and devices are shown in block diagram form in order not to obscure the description of the invention with unnecessary detail.

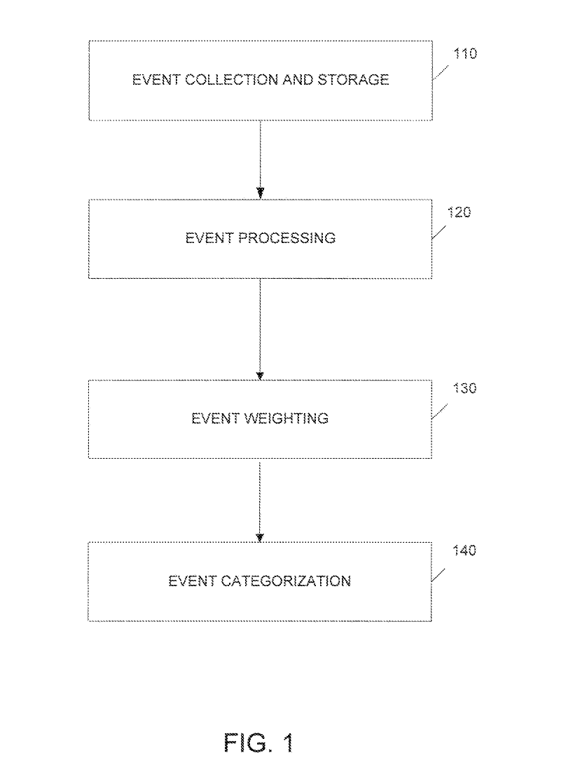

FIG. 1 is a flow diagram illustrating an event processing sequence, according to one embodiment of the invention. As shown in FIG. 1, the sequence 100 starts with data collection and storage at processing block 110. In one embodiment, data includes multiple events performed within one or more user search and navigation sessions. A user search and navigation session encompasses activity that a user entity having a unique Internet Protocol (IP) address such as, for example, a user or an agent of the user, performs in a predetermined period of time, which may or may not overlap with previous sessions associated with the same user.

In one embodiment, users or respective agents of users access an entity over a network, such as, for example, the Internet, and input various data, which is subsequently captured by selective processing modules within the network-based entity. The user input typically comprises one or more “events.” The events are then stored within one or more event logs to be used in subsequent generation of catalogs or behavioral profiles.

In one embodiment, an event is a type of action initiated by the user, typically through a conventional mouse click command. Events include, for example, advertisement clicks, search queries, search clicks, sponsored listing clicks, page views and advertisement views. However, events, as used herein, may include any type of online navigational interaction or search-related events.

Generally, a page view event occurs when the user views a web page. In one example, a user may enter a web page for music within an Internet portal by clicking on a link for the music category page. Thus, a page view event is recorded for the user's view of the music category page. In one embodiment, the page view event may be classified by the text occurring on the web page. In addition, the co-occurrence or sequence of page view events may be used to classify a set of page view events.

An advertisement view event occurs when the user views a web page that shows one or more advertisements. For example, an Internet portal may display banner advertisements on the home page of the portal. Thus, one page view by the user generates multiple advertisement views, one for each banner ad displayed on the web page.

An advertisement click event occurs when a user clicks on an advertisement. For example, a web page may display a banner advertisement. An advertisement click event occurs when the user clicks on the banner advertisement.

A search query event occurs when a user submits one or more search terms within a search query to a web-based search engine. For example, a user may submit the query “Preowned Toyota Tundra”, and a corresponding search query event containing the search terms “Preowned,” “Toyota,” and “Tundra” is recorded. In response to a user query, a web-based search engine returns a plurality of links to web pages relevant to the corresponding search query terms. If a user clicks on one of the links, a search click event occurs.

A sponsored listing advertisement refers to advertisements that are displayed in response to a user's search criteria. A sponsored listing click event occurs when a user clicks on a sponsored listing advertisement displayed for the user.

Next, referring back to FIG. 1, event processing is performed at processing block 120. In one embodiment, each event is processed and one or more event features are extracted, the event features being subsequently used to characterize the specific event, as described in further detail below.

The sequence 100 continues at processing block 130 with weighting of the received events. In one embodiment, a count is initiated, the count value embodying the number of times each event occurred in the past, as described in further detail below. Furthermore, a weight parameter value is calculated for each processed event based on the count value, as described in further detail below.

Finally, at processing block 140, each event is categorized according to its calculated weight parameter value, as described in detail below, and further stored within one or more associated data storage modules, such as, for example, one or more databases.

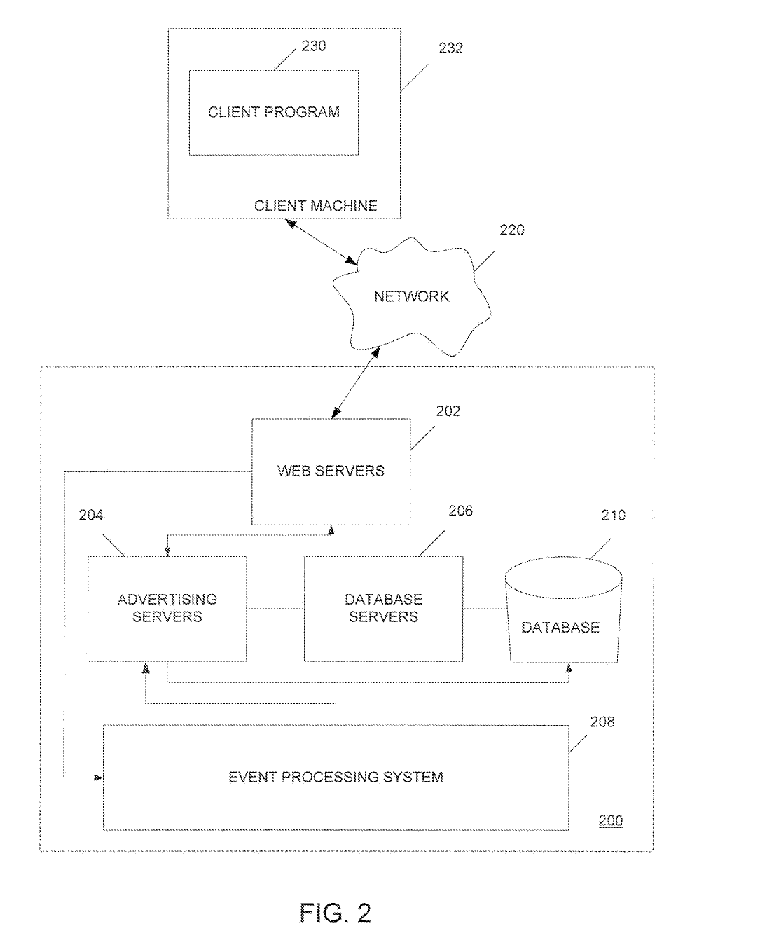

FIG. 2 is a block diagram illustrating an exemplary network-based entity, which facilitates automatic event weighting and categorization. While an exemplary embodiment of the present invention is described within the context of an entity 200 enabling automatic weighting and categorization of events, it will be appreciated by those skilled in the art that the invention will find application in many different types of computer-based, and network-based, entities, such as, for example, commerce entities, content provider entities, or other known entities having a presence on the network.

In one embodiment, the entity 200, such as, for example, an Internet portal, includes one or more front-end web processing servers 202, which may, for example, deliver web pages to multiple users, (e.g., markup language documents), handle search requests to the entity 200, provide automated communications to/from users of the entity 200, deliver images to be displayed within the web pages, deliver content information to the users, and other processing servers, which provide an intelligent interface to the back-end of the entity 200.

The entity 200 further includes one or more back-end servers, for example, one or more advertising servers 204, and one or more database servers 206, each of which maintaining and facilitating access to one or more respective databases 210. In one embodiment, the advertising servers 204 are coupled to a respective database 210 and are configured to select and transmit content, such as, for example, advertisements, sponsored links, integrated links, and other types of advertising content, to users via the network 220. In one embodiment, the entity 200 further includes an event processing system 208, such as a system to facilitate automatic event weighting and categorization within the network-based entity 200, as described in further detail below, the system 208 being coupled to the web servers 202 and the advertising servers 204.

The network-based entity 200 may be accessed by a client program 230, such as a browser (e.g., the Internet Explorer browser distributed by Microsoft Corporation of Redmond, Wash.) that executes on a client machine 232 and accesses the entity 200 via a network 220, such as, for example, the Internet. Other examples of networks that a client may utilize to access the entity 200 includes a wide area network (WAN), a local area network (LAN), a wireless network (e.g., a cellular network), the Plain Old Telephone Service (POTS) network, or other known networks.

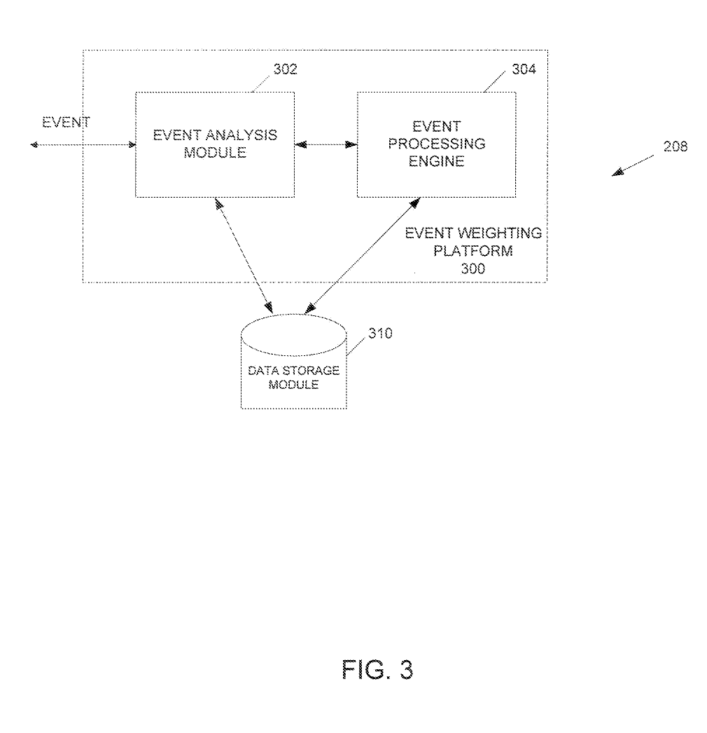

FIG. 3 is a block diagram illustrating a system 208 to facilitate automatic event weighting and categorization within the network-based entity 200, according to one embodiment of the invention. As illustrated in FIG. 2, the system 208 includes an event weighting and categorization platform 300 coupled to one or more data storage modules, of which data storage module 310 is shown in FIG. 3. In one embodiment, the data storage module 310 further includes one or more event logs, and one or more databases or datastores.

The event logs store various events, collected automatically or, in the alternative, manually, during user search and navigation sessions from various servers within the entity 200, from editors associated with the entity 200, and/or from other third-party entities connected to the entity 200 via the network 220. The event weighting and categorization platform 300 retrieves the stored events from the event logs within the data storage module 310, such as, for example, search queries transmitted by users or user agents via the network 220, web page views, advertising page views, search results clicks, advertisement clicks, and/or other types of interactive events, and enables automatic weighting and categorization of the events, as described in further detail below.

Each database or datastore within the data storage module 310 is configured to implement and support at least partially the system 208 and to store data to be used in conjunction with the event weighting and categorization platform 300. In one embodiment, the databases may be implemented as relational databases, and may include a number of tables having entries, or records, that are linked by indices and keys. Alternatively, the databases may be implemented as collection of objects in an object-oriented database.

In one embodiment, the event weighting and categorization platform 300 further includes an event analysis module 302 configured to receive an event and to analyze the event in order to extract one or more event features. In one example, the event analysis module 302 may be a parser module configured to receive a search query and to parse the search query to retrieve one or more event units, such as, for example, query terms. Considering the search query detailed above, “Preowned Toyota Tundra,” the event analysis module 302 parses the query to retrieve the query terms “Preowned,” “Toyota,” and “Tundra.” In alternate embodiments, the event analysis module 302 may be a filtering module configured to filter the received events, a generalization module configured to generalize the received events, and/or a clustering module configured to cluster the received events into an advantageous number of groups, according to respective known filtering, generalizing, and/or clustering techniques.

The event categorization platform 300 further includes an event processing engine 304 coupled to the event analysis module 302 and configured to receive the extracted event features from the module 302 and to categorize the event based on the event features and on assigned event weight parameter values, as described in further detail below.

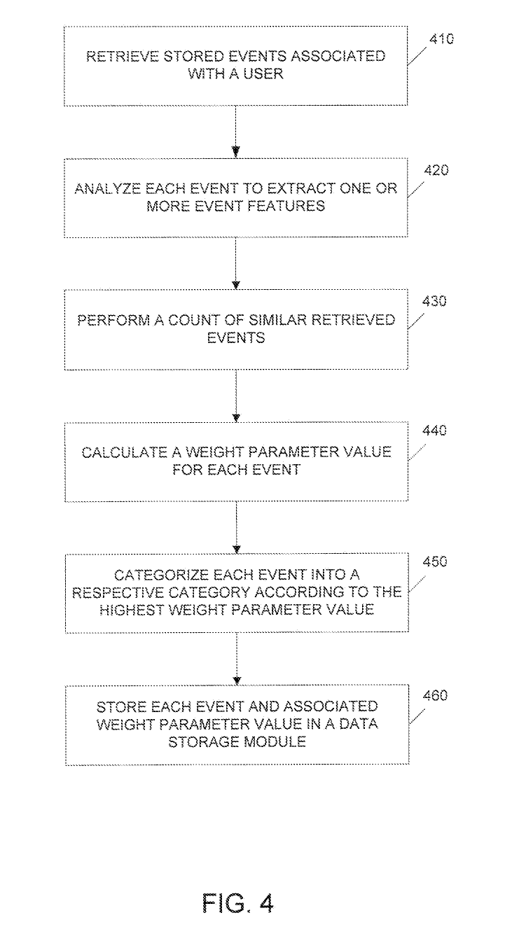

FIG. 4 is a flow diagram illustrating a method to facilitate automatic categorization of events in a network, according to one embodiment of the invention. As illustrated in FIG. 4, at processing block 410, events associated with a user or an agent of the user and stored in one or more event logs within the data storage module 310 are retrieved. In one embodiment, the platform 300 retrieves the stored events from the event logs within the module 310, such as, for example, search queries transmitted by users via the network 220, web page views, advertising page views, search results clicks, ad clicks, and/or other types of interactive events performed by the user or a user's agent during a predetermined number of user sessions.

At processing block 420, each event is analyzed to extract or generate one or more event features. In one embodiment, the event analysis module 302 parses an event, such as, for example, a search query, to obtain one or more units (e.g., query terms), and further transmits the event units to the event processing engine 304. If, for example, the user inputs the “Preowned Toyota Tundra” search query, the module 302 parses the query to obtain query terms, such as, for example, “Preowned,” “Toyota,” “Tundra,” and/or a combination of the query terms, such as, for example, “Toyota Tundra,” and further transmits the resulting query terms to the engine 304. In an alternate embodiment, the module 302 clusters a number of events, such as, for example, page views, into a representative category. If, for example, the user views web pages related to automobiles and also views web pages related to technical engine specifications for Toyota Tundra trucks, then the event analysis module 302 clusters the page views into a “Technology” category, for example, and transmits the results to the engine 304.

At processing block 430, a count of similar retrieved events is performed. In one embodiment, the event processing engine 304 counts similar stored events and aggregates the occurrence of such events to determine a count value representing the number of times certain events occur in a particular sequence. If, for example, the event processing engine 304 counts the occurrence of the search query “Preowned Toyota Tundra” (PTT) prior to a click event on an advertisement related to a “boats” category (ad click “boats”), then a specific count value N is registered. In addition, if the event processing engine 304 counts the occurrence of the search query “Preowned Toyota Tundra” (PTT) prior to an ad view event on an advertisement related to a “boats” category (ad view “boats”), then a specific count value M is registered. In one embodiment, the aggregated events and the respective count values may be further stored within the data storage module 310.

At processing block 440, a weight parameter value is calculated for each aggregated event. In one embodiment, the event processing engine 304 calculates a weight parameter value for each event using a known machine-learning unit (not shown), such as, for example, a known support vector machine (not shown), or, in the alternative, a known Naïve Bayes machine, a known neural network structure (not shown), a known linear regression mechanism (not shown), or any other known machine-learning unit. In one embodiment, the event weighting and categorization platform 300 further includes the machine-learning unit coupled to the event processing engine 304. Alternatively, the machine-learning unit may reside externally and may be coupled to the event processing engine 304.

Using for example a known standard Naïve Bayes classification method, in one embodiment, the weight parameter value may be calculated as follows:

weight=log(P(event|ad click)/P(event|non-ad click)

where the weight parameter value represents the probability of an advertisement click when the specific event is performed by the user. In the example described above, the weight value of the PTT event, and the probability that a click on an advertisement related to a “Boats” category may happen subsequent to the PTT event, may be calculated with the above formula as follows:

weight (PTT)=log(P(PTT|ad click “Boats”)/P(PTT|ad view “Boats”)

At processing block 450, each event is categorized into a respective category according to the highest calculated weight parameter value. In one embodiment, the event processing engine 304 assigns each event to a respective category according to the respective calculated weight parameter value.

Finally, at processing block 460, each event and its associated weight parameter value are stored within the data storage module 310. In one embodiment, the event processing engine 304 stores each event and its associated weight parameter value within respective tables of databases within the data storage module 310.

In one embodiment, the event processing system 208 and the associated methods to facilitate automatic weighting and categorization of events and to further facilitate automatic scoring of users within the network 220, described in detail in connection with FIGS. 4, 7 and 8, are used in a behavioral targeting system, which is configured to identify interests of users based on the users' online activities.

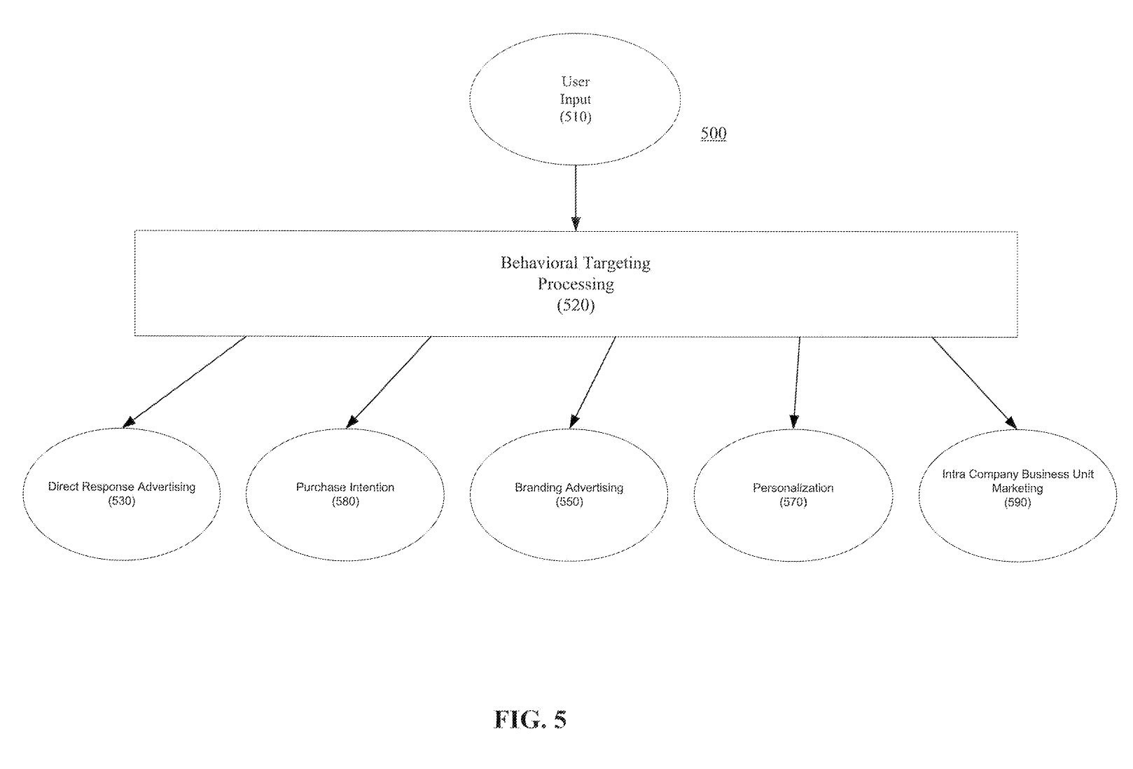

FIG. 5 is a block diagram illustrating a generalized behavioral targeting system. The behavioral targeting system 500 includes a behavioral targeting processing module 520, which captures the user input 510, such as, for example, one or more events. The behavioral targeting processing module 520 generates a plurality of user interest profiles specific for a target objective. A user interest profile further provides an indication of interest in a subject matter for a particular objective. For example, the user profile output may indicate that the user is a good candidate for a particular objective regarding a “finance” topic, and a poor candidate for the specific objective regarding a “music” topic.

In one embodiment, the behavioral targeting processing module 520 generates user interest profiles for marketing objectives. As shown in FIG. 5, the behavioral targeting system 500 outputs user interest profiles for direct response advertising (530), brand awareness advertising (550), personalization activities (570), and purchase intention activities (580).

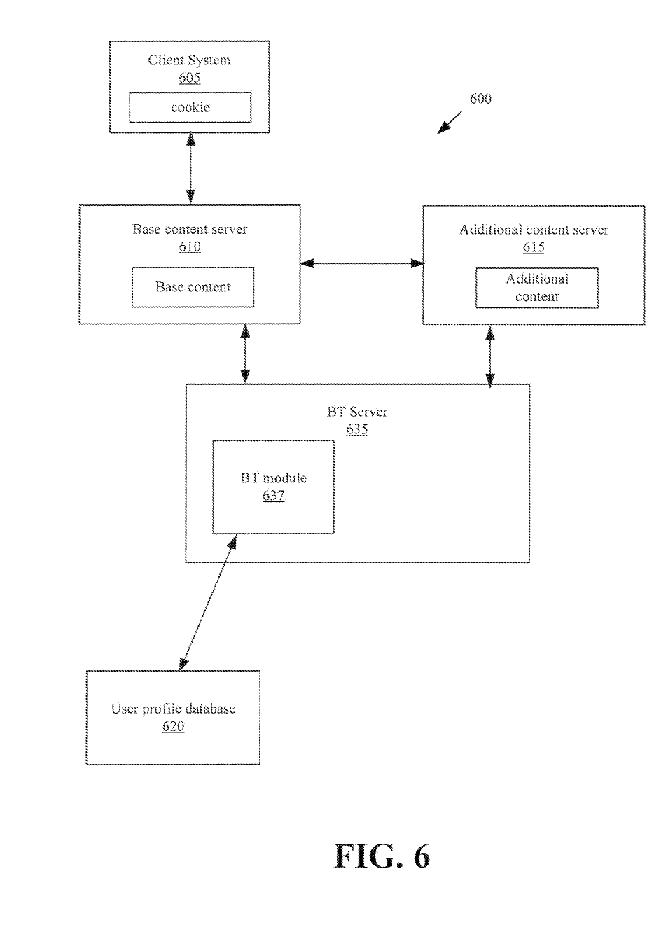

FIG. 6 shows a conceptual diagram of a targeting system 600. The targeting system 600 includes a client system 605, a base content server 610 for containing base content, an additional content server 615 for additional content, a database of user profiles 620, and a behavioral targeting server 635. The behavioral targeting server 635 comprises an optimizer module 638 that receives event information. The targeting system 600 is configured to select additional content to be sent to a user based on the user's profile. The client system 605 is configured to receive the base and additional content and display the base and additional content to the user (e.g., as a published web page). Various portions of the optimization system may reside in one or more servers such as servers residing within the entity 200 of FIG. 2 and/or one or more client systems, such as the exemplary client machine 232 of FIG. 2.

The user profile database 620 stores user profiles for a plurality of users/client systems, each user profile having a unique user-identification number assigned for a particular client system 605 used by a user. The user-identification number may be stored, for example, on the client system 605 used by the user. When a user requests content from a base content server 610, the targeting server 635 selectively uses the user-identification number to retrieve the particular user profile from the user profile database 620.

The targeting system may be implemented in either hardware or software. For the software implementation, the targeting system is software that includes a plurality of computer executable instructions for implementation on a general-purpose computer system. Prior to loading into a general-purpose computer system, the targeting system software may reside as encoded information on a computer readable medium, such as a magnetic floppy disk, magnetic tape, and compact disc read only memory (CD-ROM). One example of a behavioral targeting system is described in detail in U.S. patent application Ser. No. 11/394,343 to Joshua Koran et al., filed on 29 Mar. 2006, and entitled “Behavioral Targeting System,” which is incorporated by reference herein in its entirety.

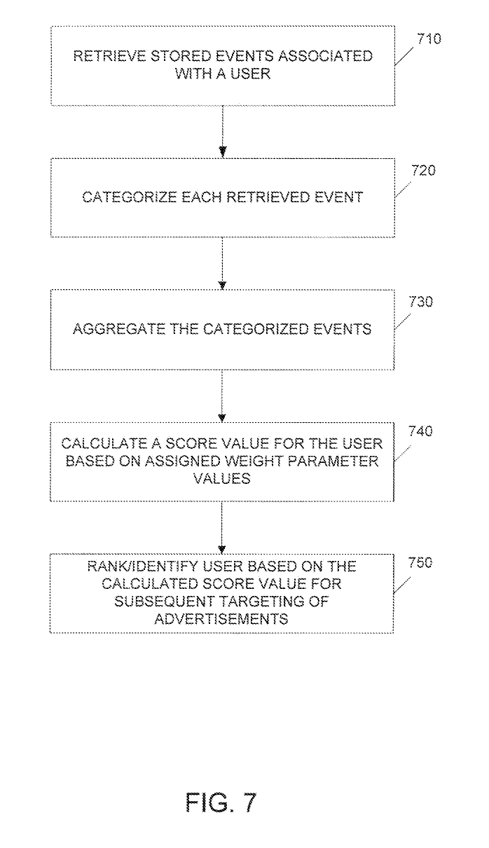

FIG. 7 is a flow diagram illustrating a method to facilitate automatic scoring of users in a network, according to one embodiment of the invention. As shown in FIG. 7, at processing block 710, stored events associated with a user are retrieved from event logs stored within a data storage module, such as, for example, the data storage module 310 of FIG. 3.

At processing block 720, the retrieved events are categorized. In one embodiment, each event is categorized as described in detail above in connection with FIG. 4 and then stored together with the corresponding calculated weight parameter value. Alternatively, each event may be categorized using one of many known categorization methods and the categorized event may be stored within the data storage module.

At processing block 730, the categorized events are aggregated. In one embodiment, similar events within the same category are aggregated to reduce the amount of input data, such as, for example, by calculating a weighted sum of the similar events based on the respective weight values described in detail above. In one embodiment, the event processing engine 304 performs the aggregation of similar events. Alternatively, the aggregation may be performed by other components and/or modules within the entity 200.

At processing block 740, a score value is calculated for the user based on the assigned weight parameter values of the stored events. Considering the embodiment described in detail above, and using a standard Naïve Bayes classification method, the score may be calculated as follows:

score=sum(weight)+log(P(ad click)/P(non-ad click)=log(P(event|ad click)/P(event|non-ad click)*(P(ad click)/P(non-ad click))

In one embodiment, the event processing engine 304 performs the calculation of score values. Alternatively, the computation may be performed by other components and/or modules within the entity 200.

Finally, at processing block 750, the user is ranked based on the corresponding calculated score value for subsequent targeting of advertisements. In one embodiment, the user may be ranked in sorted decreasing order and/or particular users may be identified for additional processing.

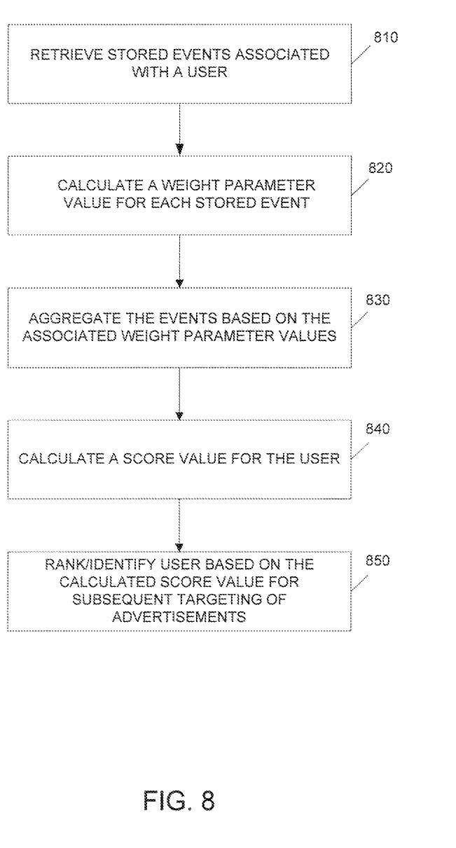

FIG. 8 is a flow diagram illustrating a method to facilitate automatic scoring of users in a network, according to an alternate embodiment of the invention. As shown in FIG. 8, at processing block 810, stored events associated with a user are retrieved from event logs stored within a data storage module, such as, for example, the data storage module 310 of FIG. 3.

At processing block 820, a weight parameter value is calculated for each stored event. In one embodiment, the weight parameter value is calculated as described in detail above for each event and is stored in association with the specific event.

At processing block 830, the retrieved events are aggregated based on their associated weight parameter values. In one embodiment, the retrieved events are aggregated using a weighted aggregation process, whereby each event's contribution to the aggregated value is weighted by the corresponding weight parameter value calculated above in connection with processing block 820. In one embodiment, the aggregated value may include a count value, or in the alternative, an “intensity” value, and/or a “recency” value, and/or a “frequency” value, or any other value, as described, for example, in U.S. patent application Ser. No. 11/394,343 to Joshua Koran et al., filed on 29 Mar. 2006, and entitled “Behavioral Targeting System.”

In one embodiment, the event processing engine 304 performs the aggregation of the retrieved events. Alternatively, the aggregation may be performed by other components and/or modules within the entity 200.

At processing block 840, a score value is calculated for the user. In one embodiment, the score value is calculated based on a scoring function of the associated aggregated values, which optimizes a known scoring goal and may be input into a known machine learning process, as described, for example in U.S. patent application Ser. No. 11/394,343 to Joshua Koran et al., filed on 29 Mar. 2006, and entitled “Behavioral Targeting System.”

In one embodiment, the event processing engine 304 performs the calculation of score values. Alternatively, the computation may be performed by other components and/or modules within the entity 200.

Finally, at processing block 850, the user is ranked based on the corresponding calculated score value for subsequent targeting of advertisements. In one embodiment, the user may be ranked in sorted decreasing order and/or particular users may be identified for additional processing.

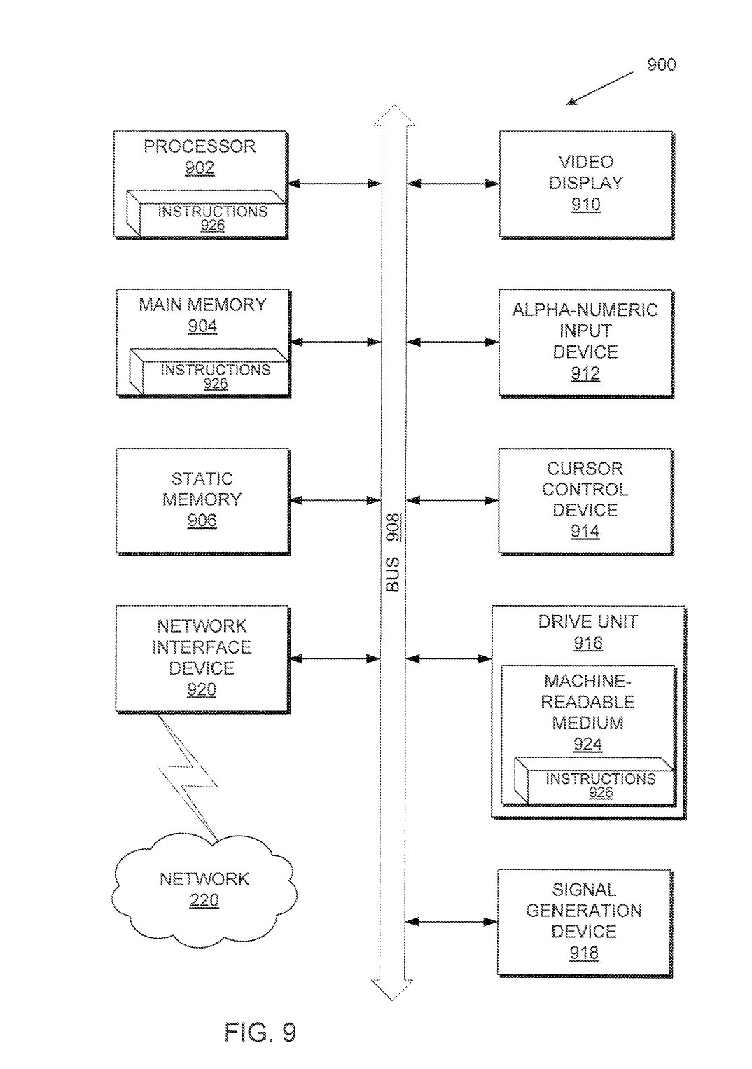

FIG. 9 shows a diagrammatic representation of a machine in the exemplary form of a computer system 900 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 900 includes a processor 902, a main memory 904 and a static memory 908, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a cursor control device 914 (e.g., a mouse), a disk drive unit 918, a signal generation device 918 (e.g., a speaker), and a network interface device 920.

The disk drive unit 916 includes a machine-readable medium 924 on which is stored a set of instructions (i.e., software) 926 embodying any one, or all, of the methodologies described above. The software 926 is also shown to reside, completely or at least partially, within the main memory 904 and/or within the processor 902. The software 926 may further be transmitted or received via the network interface device 920.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
retrieving a plurality of events associated with a user from a data storage module;
calculating a weight parameter value for each event of said plurality of events; and
assigning said each event to a predetermined category based on said calculated weight parameter value.

2. The method according to claim 1, further comprising storing said each event and said associated weight parameter value within said data storage module in connection with said predetermined category.

3. The method according to claim 1, further comprising analyzing said each event to extract at least one event feature.

4. The method according to claim 3, wherein said calculating further comprises:
performing at least one count of similar events of said plurality of events;
aggregating said similar events into a plurality of aggregated events; and
calculating said weight parameter value for each event of said plurality of aggregated events.

5. The method according to claim 1, further comprising:
calculating a score value for said user based on said weight parameter value calculated for said each event; and
rank said user based on said calculated score value.

6. The method according to claim 4, wherein said weight parameter value is a probability of an advertisement click event when said associated aggregated event is performed by said user.

7. The method according to claim 1, further comprising:
aggregating similar events within said plurality of events within said predetermined category; and
calculating a score value for said user based on said weight parameter value obtained for each of said similar events.

8. A computer readable medium containing executable instructions, which, when executed in a processing system, cause said processing system to perform a method comprising:
retrieving a plurality of events associated with a user from a data storage module;
calculating a weight parameter value for each event of said plurality of events; and
assigning said each event to a predetermined category based on said calculated weight parameter value.

9. The computer readable medium according to claim 8, wherein said method further comprises storing said each event and said associated weight parameter value within said data storage module in connection with said predetermined category.

10. The computer readable medium according to claim 1, wherein said method further comprises analyzing said each event to extract at least one event feature.

11. The computer readable medium according to claim 10, wherein said calculating further comprises:
performing at least one count of similar events of said plurality of events;
aggregating said similar events into a plurality of aggregated events; and
calculating said weight parameter value for each event of said plurality of aggregated events.

12. The computer readable medium according to claim 8, wherein said method further comprises:
calculating a score value for said user based on said weight parameter value calculated for said each event; and
rank said user based on said calculated score value.

13. The computer readable medium according to claim 11, wherein said weight parameter value is a probability of an advertisement click event when said associated aggregated event is performed by said user.

14. The computer readable medium according to claim 8, wherein said method further comprises:
aggregating similar events within said plurality of events within said predetermined category; and
calculating a score value for said user based on said weight parameter value obtained for each of said similar events.

15. A system comprising:
at least one data storage module; and
an event weighting and categorization platform coupled to said at least one data storage module, said platform to retrieve a plurality of events associated with a user from a data storage module, to calculate a weight parameter value for each event of said plurality of events, and to assign said each event to a predetermined category based on said calculated weight parameter value.

16. The system according to claim 15, wherein said platform further stores said each event and said associated weight parameter value within said data storage module in connection with said predetermined category.

17. The system according to claim 1, wherein said platform further analyzes said each event to extract at least one event feature.

18. The system according to claim 17, wherein said platform further performs at least one count of similar events of said plurality of events, aggregates said similar events into a plurality of aggregated events, and calculates said weight parameter value for each event of said plurality of aggregated events.

19. The system according to claim 15, wherein said platform further calculates a score value for said user based on said weight parameter value calculated for said each event, and ranks said user based on said calculated score value.

20. The system according to claim 18, wherein said weight parameter value is a probability of an advertisement click event when said associated aggregated event is performed by said user.

21. The system according to claim 15, wherein said platform further aggregates similar events within said plurality of events within said predetermined category, and calculates a score value for said user based on said weight parameter value obtained for each of said similar events.
